(19) United States
(12) Patent Application Publication
(10) Pub. No.: US 2026/0367951 A1
(43) Pub. Date: Nov. 19, 2026

(54) METHODS AND SYSTEMS FOR REDUCING APPLICATION LAUNCH-TIME IN AN ELECTRONIC DEVICE

(71) Applicant: Samsung Electronics Co., Ltd., Suwon-si (KR)

(72) Inventors: Munish JINDAL, Bengaluru (IN); Divyanshu CHUCHRA, Bengaluru (IN); Akshat SRIVASTAVA, Bengaluru (IN); Mahesh KUMAR, Bengaluru (IN); Rajesh Padebettu SRINIVAS, Bengaluru (IN); Anurag AZAD, Bengaluru (IN); Kashin Brij KHAJURIA, Bengaluru (IN); Indrajit Kumar DAS, Bengaluru (IN); Sharan Kumar ALLUR, Bengaluru (IN)

(21) Appl. No.: 19/733,170

(22) Filed: Jul. 7, 2026

Related U.S. Application Data
(63) Continuation of application No. PCT/KR2025/000331, filed on Jan. 7, 2025.

(30) Foreign Application Priority Data
Jan. 16, 2024 (IN) 202441003177
Dec. 6, 2024 (IN) 2024 41003177

(51) Int. Cl. G06F 9/455; G06F 9/451

(52) U.S. Cl. CPC G06F 9/45508; G06F 9/451

(57) ABSTRACT

Methods and systems for reducing application launch-time in an electronic device are provided. The method includes creating scripts of at least one application deployed in the electronic device. Further, the method includes generating shader data and pipeline data by executing the created scripts of the at least one application. The method includes bundling the generated shader data and the generated pipeline data with an operating system binary of the electronic device. The method includes embedding the bundled shader data and the bundled pipeline data into the at least one application at a time of booting the electronic device. Further, the method includes initializing the at least one application using the embedded shader data and the embedded pipeline data.

### CROSS-REFERENCE TO RELATED APPLICATION(S)

This application is a continuation application, claiming priority under 35 U.S.C. § 365(c), of an International application No. PCT/KR2025/000331, filed on Jan. 7, 2025, which is based on and claims the benefit of an Indian Provisional patent application number 202441003177, filed on Jan. 16, 2024, in the Indian Office of Intellectual Property, and of an Indian Complete patent application number 202441003177, filed on Dec. 6, 2024, in the Indian Office of Intellectual Property, the disclosure of each of which is incorporated by reference herein in its entirety.

### BACKGROUND

### 1. Field

The disclosure relates to graphic rendering for applications in electronic devices. More particularly, the disclosure relates to a method and a system for reducing application launch-time of applications in an electronic device.

### 2. Description of Related Art

Graphics rendering is a crucial feature for electronic devices, such as smartphones or tablets, in order to generate smooth animations, high-quality visuals, and immersive three-dimensional (3D) environments, essential for various applications deployed in such devices. Generally, the electronic devices are deployed with various graphic rendering frameworks, such as SKIA with Vulkan application programming interface (API), which is implemented on a Graphics Processing Unit (GPU) of such devices. The graphic rendering frameworks are deployed to generate and process a graphic pipeline for performing graphic rendering corresponding to the applications in the electronic device. Currently, the graphic rendering frameworks employ dynamic shader generation and Just-in-Time (JIT) compilation for a first-time launch of the applications and subsequently stores the compiled shader and pipeline cache in a persistence cache for a second-time launch of the applications. This leads to a problem of facing initial jank as application launch time is severely impacted. For example, in a mobile application that utilizes Android two-dimensional (2D) Rendering with SKIA and Vulkan API, the initial launch of the application may experience delays and jitters due to the dynamic shader generation and JIT compilation. This can lead to a suboptimal user experience, especially for first-time users who may encounter performance issues during the initial launch of the applications.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a system for reducing application launch-time of applications in an electronic device.

Additional aspects will be set forth in part in the description which follows and, in part, will be apparent from the description, or may be learned by practice of the presented embodiments.

In accordance with an aspect of the disclosure, a method for reducing application launch-time in an electronic device is provided. The method includes creating scripts of at least one application deployed in the electronic device. Further, the method includes generating shader data and pipeline data by executing the created scripts of the at least one application. The method includes bundling the generated shader data and the generated pipeline data with an operating system binary of the electronic device. The method includes embedding the bundled shader data and the bundled pipeline data into the at least one application at a time of booting the electronic device. Further, the method includes initializing the at least one application using the embedded shader data and the embedded pipeline data.

In accordance with another aspect of the disclosure, a system for reducing application launch-time in an electronic device is provided. The system includes memory storing one or more instructions, and at least one processor communicatively coupled to the memory. The instructions, when executed by the at least one processor individually or collectively, cause the system to create scripts of at least one application deployed in the electronic device. Further, the at least one processor is the instructions, when executed by the at least one processor individually or collectively, cause the system to generate shader data and pipeline data by executing the created scripts of the at least one application. The at least one processor is configured to bundle the generated shader data and the generated pipeline data with an operating system binary of the electronic device. Further, the at least one processor is configured to embed the bundled shader data and the bundled pipeline data into the at least one application at a time of booting the electronic device. Furthermore, the at least one processor is configured to initialize the at least one application using the embedded shader data and the embedded pipeline data.

In accordance with an aspect of the disclosure, one or more non-transitory computer-readable storage media storing instructions that, when executed by at least one processor of a system individually or collectively, cause the system to perform operations for reducing application launch-time in an electronic device, is provided. The operations include creating scripts of at least one application deployed in the electronic device. Further, the operations include generating shader data and pipeline data by executing the created scripts of the at least one application. The operations include bundling the generated shader data and the generated pipeline data with an operating system binary of the electronic device. The operations include embedding the bundled shader data and the bundled pipeline data into the at least one application at a time of booting the electronic device. Further, the operations include initializing the at least one application using the embedded shader data and the embedded pipeline data.

In accordance with another aspect of the disclosure, a method for reducing launch-time of applications in an electronic device is provided. The method includes extracting, at a time of booting the electronic device, shader data and pipeline data associated with each application from among a plurality of applications installed in the electronic device. Further, the method includes bundling the extracted shader data and the extracted pipeline data with an operating system binary of the electronic device. The method includes embedding the bundled shader data and the bundled pipeline data of each application from the operating system into corresponding application resources. Further, the method includes fetching the embedded shader data and the embedded pipeline data from the corresponding application resources at a time of initializing each application in the electronic device.

In accordance with another aspect of the disclosure, a system for reducing launch-time of applications in an electronic device is provided. The system includes memory storing one or more instructions, and at least one processor communicatively coupled to the memory. The instructions, when executed by the at least one processor individually or collectively, cause the system to extract, at a time of booting the electronic device, shader data and pipeline data associated with each application from among a plurality of applications installed in the electronic device. The at least one processor is configured to bundle the extracted shader data and the extracted pipeline data with an operating system binary of the electronic device. Further, the at least one processor is configured to embed the bundled shader data and the bundled pipeline data of each application from the operating system into corresponding application resources. Furthermore, the at least one processor is configured to fetch the embedded shader data and the embedded pipeline data from the corresponding application resources at a time of initializing each application in the electronic device.

In accordance with an aspect of the disclosure, one or more non-transitory computer-readable storage media storing instructions that, when executed by at least one processor of a system individually or collectively, cause the system to perform operations for reducing application launch-time in an electronic device, is provided. The operations include extracting, at a time of booting the electronic device, shader data and pipeline data associated with each application from among a plurality of applications installed in the electronic device. Further, the operations include bundling the extracted shader data and the extracted pipeline data with an operating system binary of the electronic device. The operations include embedding the bundled shader data and the bundled pipeline data of each application from the operating system into corresponding application resources. Further, the operations include fetching the embedded shader data and the embedded pipeline data from the corresponding application resources at a time of initializing each application in the electronic device.

Other aspects, advantages, and salient features of the disclosure will become apparent to those skilled in the art from the following detailed description, which, taken in conjunction with the annexed drawings, discloses various embodiments of the disclosure.

### B RIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram depicting a system having a workstation in communication with an electronic device, according to an embodiment of the disclosure;

FIG. 2 illustrates a block diagram depicting generation of shader data and pipeline data, according to an embodiment of the disclosure;

FIG. 3 illustrates a block diagram depicting deployment of the generated shader data and the generated pipeline data in the electronic device, according to an embodiment of the disclosure;

FIG. 4 illustrates a flowchart depicting a method for reducing application launch-time in the electronic device, according to an embodiment of the disclosure;

FIG. 5A illustrates a block diagram depicting a system for reducing launch-time of applications in an electronic device, according to an embodiment of the disclosure;

FIG. 5B illustrates a block diagram depicting operations of the system for reducing launch-time of the applications in the electronic device, according to an embodiment of the disclosure; and

FIG. 6 illustrates a flowchart depicting a method for reducing launch-time of the applications in the electronic device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Embodiments of the disclosure will be described below in detail with reference to the accompanying drawings.

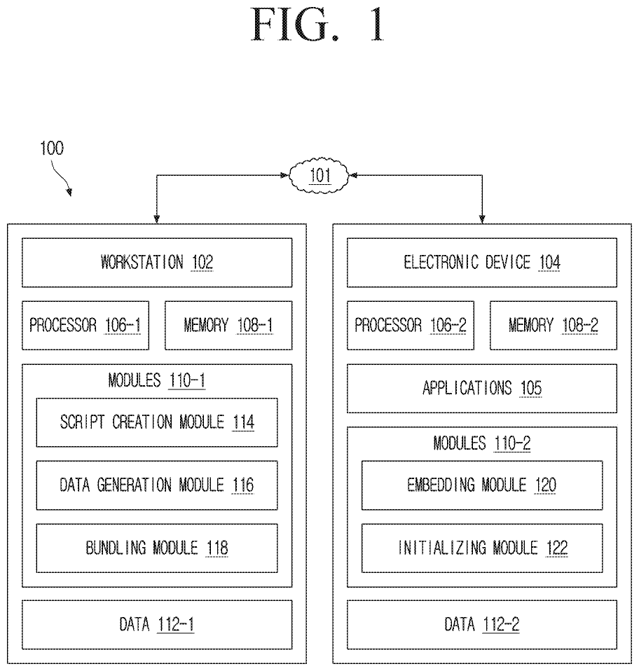

FIG. 1 illustrates a block diagram depicting a system 100 having a workstation 102 in communication with an electronic device 104, according to an embodiment of the disclosure. In an embodiment, the electronic device 104 may be embodied as a user device including, but not limited to a smartphone and a tablet, without departing from the scope of the disclosure. Further, the workstation 102 may be embodied as a factory device capable of performing various operations, such as installing/deploying Operating System(s) (OS), on the electronic device 104, without departing from the scope of the disclosure.

In an embodiment, the system 100 may be provided for reducing launch-time in the electronic device 104. In an embodiment, the system 100 may be implemented as an apparatus. The apparatus may include memory storing one or more instructions and at least one processor communicatively coupled to the memory. The instructions, when executed by the at least one processor, may cause the apparatus to perform the operations described with respect to the system 100. In particular, the system 100 may be provided for reducing launch-time of applications 105 installed in the electronic device 104. The electronic device 104 may be deployed with various graphic rendering frameworks which is implemented on a Graphics Processing Unit (GPU) (not shown) of the electronic device 104. Such graphic rendering frameworks may be deployed to generate and process a graphic pipeline for performing graphic rendering corresponding to the applications 105 to be launched in the electronic device 104.

The graphic pipeline may be referred to a series of protocols for performing graphic rendering in order to display, on the electronic device 104, two-dimensional or three-dimensional images and/or scenes associated with the applications 105. The graphic pipeline may employ shader data and pipeline data which is further compiled with the OS of the electronic device 104. The shader data may include, but is not limited to, shader programs (e.g., vertex, fragment, compute shaders) devised in programming languages like GLSL, HLSL, or SPIR-V. Further, the pipeline data may involve GPU pipeline states, such as descriptor sets, pipeline configurations, or precompiled shader binaries. The system 100 of the disclosure may be configured to provide, to the electronic device 104, the shader data and pipeline data bundled with the OS. This enables the graphic rendering frameworks, in the electronic device 104, to execute the shader data and pipeline data bundled with the OS when the applications 105 are launched on the electronic device 104. Therefore, owing to implementation of the system 100, the launch-time of the applications 105 in the electronic device 104 may be substantially reduced.

Operational and functional aspects of the system 100 are explained in detail in the subsequent paragraphs of the disclosure.

In the illustrated embodiment, referring to FIG. 1, the workstation 102 may communicate with the electronic device 104 via a network 101. The network 101 may be a wired network or a wireless network. The network 101 may include, but is not limited to, a mobile network, a broadband network, a Wide Area Network (WAN), a Local Area Network (LAN), and a Personal Area Network, without departing from the scope of the disclosure.

In the illustrated embodiment, the workstation may include a processor 106-1, memory 108-1, module(s) 110-1, and data 112-1. Further, the electronic device 104 may include a processor 106-2, memory 108-2, module(s) 110-2, the applications 105, and data 112-2. The applications 105 may be referred to programs or protocols which are either pre-installed or installed by user(s) in the electronic device 104. In an example, the applications 105 may include, but are not limited to, messaging applications, calendar applications, camera applications, map applications, gaming applications, E-mail applications, travel booking applications, weather applications, news applications, and social networking applications. Further, the modules 110-1, 110-2 and the memory 108-1, 108-2 are coupled to the respective processors 106-1, 106-2. Hereinafter, the processor 106-1 and the processor 106-2 may collectively be referred to as the processor 106. Further, the memory 108-1 and the memory 108-2 may collectively be referred to as the memory 108. Furthermore, the data 112-1 and the data 112-2 may collectively be referred to as the data 112. The module 110-1 and the module 110-2 may collectively be referred to as the module 110.

The processor 106 can be a single processing unit or a number of units, all of which could include multiple computing units. The processor 106 may be implemented as one or more microprocessors, microcomputers, microcontrollers, digital signal processors, central processing units, state machines, logic circuitries, and/or any devices that manipulate signals based on operational instructions. Among other capabilities, the processor 106 is configured to fetch and execute computer-readable instructions and data stored in the memory 108.

The memory 108 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The module(s) 110, amongst other things, include routines, programs, objects, components, data structures, etc., which perform particular tasks or implement data types. The module(s) 110 may also be implemented as, signal processor(s), state machine(s), logic circuitries, and/or any other device or component that manipulate signals based on operational instructions.

Further, the module(s) 110 may be implemented in hardware, instructions executed by at least one processing unit, for e.g., the processor 106, or by a combination thereof. The processing unit may comprise a computer, a processor, a state machine, a logic array and/or any other suitable devices capable of processing instructions. The processing unit may be a general-purpose processor which executes instructions to cause the general-purpose processor to perform operations or, the processing unit may be dedicated to perform the required functions. In some example embodiments, the module(s) 110 may be machine-readable instructions (software, such as web-application, mobile application, program, etc.) which, when executed by a processor/processing unit, perform any of the described functionalities.

In an embodiment of the disclosure, the module(s) 110 may be implemented as part of the processor 106. In another embodiment of the disclosure, the module(s) 110 may be external to the processor 106. In yet another embodiment of the disclosure, the module(s) 110 may be part of the memory 108. In another embodiment of the disclosure, the module(s) 110 may be part of hardware, separate from the processor 106.

In an implementation, the module(s) 110-1 may include a script creation module 114, a data generation module 116, and a bundling module 118. Further, the module(s) 110-2 may include an embedding module 120 and an initializing module 122. The script creation module 114, the data generation module 116, and the bundling module 118 are in communication with each other. Similarly, the embedding module 120 and the initializing module 122 are in communication with each other. Further, one or more module(s) 110-1 are in communication with one or more module(s) 110-2.

The data 112 serves, amongst other things, as a repository for storing data processed, received, and generated by one or more of the modules 110.

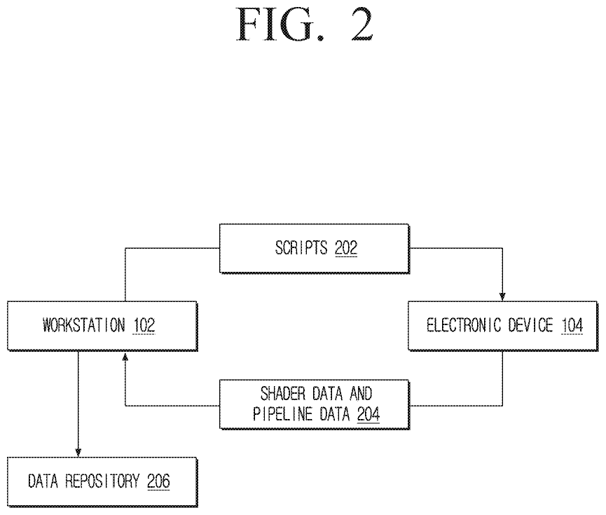

FIG. 2 illustrates a block diagram depicting generation of the shader data and the pipeline data, according to an embodiment of the disclosure. In an embodiment, the processor 106-1 may be configured to create scripts 202 of at least one application, such as at least one of the applications 105, deployed in the electronic device 104. In the illustrated embodiment, the script creation module 114 may create the scripts 202 of each application 105 deployed in the electronic device 104. The scripts 202 may be referred to a set or a sequence of protocols/commands to perform a specific task corresponding to each application 105 deployed in the electronic device 104. In an implementation, the scripts 202 may be created to cover a complete tree of application User Interface (UI). The scripts 202 may browse through all screens UI(s) of the applications and interact with all User Experience (UX) to fill dummy data for generating all application screens UI(s).

Further, the processor 106-1 may be configured to generate the shader data and the pipeline data 204 by executing the created scripts 202 of the at least one application 105. In the illustrated embodiment, the data generation module 116 may be configured to generate the shader data and the pipeline data 204 by executing the created scripts 202 of the at least one application 105 deployed in the electronic device 104. The data generation module 116 may be configured to emulate, using the created scripts 202, user interactions with each UI associated with the at least one application 105 deployed in the electronic device 104. The user actions/interaction may be referred to interactions, such as clicking buttons, entering text, interacting with menus, and performing other tasks, corresponding to the at least one application 105. In an embodiment, the data generation module 116 may be deployed with an automated UI tool to navigate each UI, using the created scripts 202, of the at least one application 105 deployed in the electronic device 104.

The data generation module 116 may be configured to generate the shader data and the pipeline data 204 associated with each UI of the at least one application 105 based on the emulating of the user interactions. Further, the data generation module 116 may be configured to store the generated shader data and the generated pipeline data 204 in a data repository 206. In one or more embodiments, the data repository 206 may be embodied as a standalone repository or the memory 108-1 of the workstation 102, without departing from the scope of the disclosure.

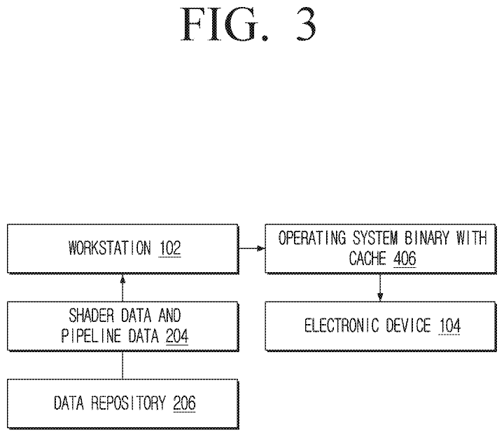

FIG. 3 illustrates a block diagram depicting deployment of the generated shader data and the generated pipeline data 204 in the electronic device 104, according to an embodiment of the disclosure. In an embodiment, the processor 106-1 may be configured to extract, from the data repository 206, the generated shader data and the generated pipeline data 204 corresponding to the at least one application deployed in the electronic device 104. Further, the processor 106-1 may be configured to bundle the generated shader data and the generated pipeline data 204, as extracted from the data repository 206, with an OS binary of the electronic device 104.

In the illustrated embodiment, the bundling module 118 may be configured to bundle the generated shader data and the generated pipeline data 204 with the OS binary of the electronic device. The bundled data, i.e., the shader data and the generated pipeline data with the OS binary, may be referred to as the OS binary with cache 406 in the FIG. 3 of the disclosure. Further, in an embodiment, the OS binary with cache 406 may interchangeably be referred to as the bundled shader data and the bundled pipeline data 406. In an embodiment, the bundling of the generated shader data and the generated pipeline data 204 may involve converting external files, such as configuration files, models, or datasets, into a format that can be included within a source code of the OS. Upon completion of bundling, the data may become an integral part of the executable file corresponding to the OS. In one or more embodiment, the bundling module may be deployed with various tools/protocols and methods for bundling the OS binaries and, depending on a programming language used for the OS.

Further, the processor 106-1 may be configured to deploy the OS along with the bundled shader data and the bundled pipeline data 406 in the electronic device 104. In an embodiment, the processor 106-2 of the electronic device 104 may be configured to embed the bundled shader data and the bundled pipeline data 406 into the at least one application 105 at a time of booting the electronic device 104. In the illustrated embodiment, the embedding module 120 may be configured to embed the bundled shader data and the bundled pipeline data 406 into application resources of the at least one application 105. In an embodiment, the application resources may be referred to various application files, assets, and data required for optimal functioning of the particular application.

In an embodiment, the processor 106-2 may be configured to initialize the at least one application 105 using the embedded shader data and the embedded pipeline data. In the illustrated embodiment, the initializing module 122 may be configured to initialize each application using the embedded shader data and the embedded pipeline data. The initializing module 122 may be configured to extract the embedded shader data and the embedded pipeline data from the application resources associated with the at least one application 105. Further, the initializing module 122 may be configured to initialize the at least one application 105 by rendering UI elements associated with UI of the at least one application 105 based on the extracted shader data and the extracted pipeline on the electronic device 104.

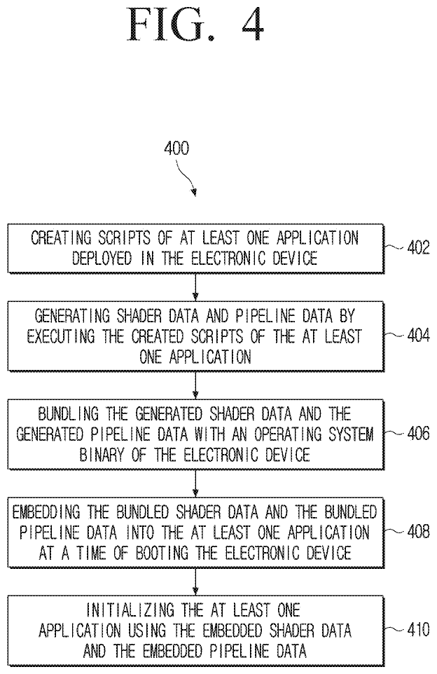

FIG. 4 illustrates a flowchart depicting a method 400 for reducing application launch-time in the electronic device 104, according to an embodiment of the disclosure. The method 400 may be implemented in the system 100 using components thereof, as described above. In an embodiment, the method 400 may be executed by the processors 106-1, 106-2 of the system 100, as described above. Further, for the sake of brevity, details of the disclosure that are explained in detail in the description of FIGS. 1 to 3 are not explained in detail in the description of FIG. 4.

At operation 402, the method 400 may include creating the scripts 202 of the at least one application 105 deployed in the electronic device 104.

At operation 404, the method 400 may include generating the shader data and the pipeline data 204 by executing the created scripts 202 of the at least one application 105. In an embodiment, the method 400 may include emulating, using the created scripts 202, the user interactions with each User Interface (UI) associated with each application deployed in the electronic device 104. Further, the method 400 may include generating the shader data and the pipeline data 204 associated with each UI of the at least one application 105 based on the emulating of the user interactions. Furthermore, the method 400 may include storing the generated shader data and the generated pipeline data 204 in the data repository 206. The method may further include extracting, from the data repository 206, the generated shader data and the generated pipeline data 204 corresponding to the at least one application 105 deployed in the electronic device 104 for further processing.

At operation 406, the method 400 may include bundling the generated shader data and the generated pipeline data 204 with the OS binary of the electronic device 104. The generated shader data and the generated pipeline data 204 may be extracted from the data repository 206 for bundling with the OS binary. Upon bundling, the method 400 may include deploying the OS along with the bundled shader data and the bundled pipeline data 406 in the electronic device 104.

At operation 408, the method 400 may include embedding the bundled shader data and the bundled pipeline data 406 into the at least one application 105 at the time of booting the electronic device 104. In an embodiment, the method 400 may include embedding the bundled shader data and the bundled pipeline data 406 into the application resources associated with the at least one application 105.

At operation 410, the method 400 may include initializing the at least one application 105 using the embedded shader data and the embedded pipeline data. In an embodiment, the method 400 may include extracting the embedded shader data and the embedded pipeline data from the application resources associated with the at least one application 105. Further, the method 400 may include initializing the at least one application 105 by rendering the UI elements associated with the UI of the at least one application 105 based on the extracted shader data and the extracted pipeline on the electronic device 104.

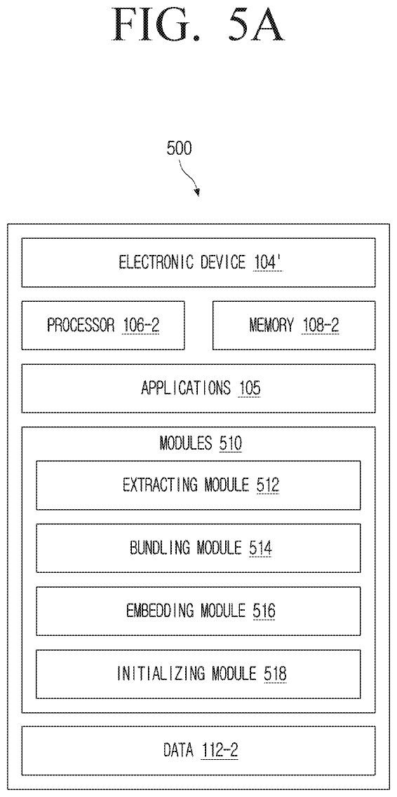

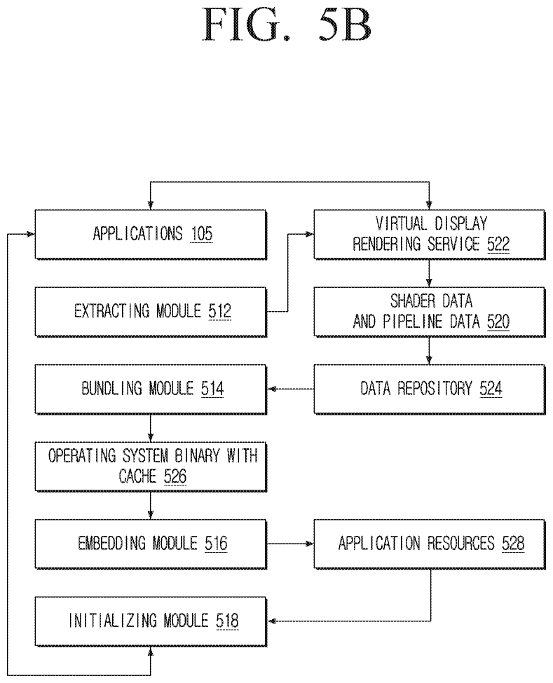

FIG. 5A illustrates a block diagram depicting a system 500 for reducing launch-time of the applications 105 in an electronic device 104′, according to an embodiment of the disclosure. FIG. 5B illustrates a block diagram depicting operations of the system 500 for reducing launch-time of the applications 105 in the electronic device 104′, according to an embodiment of the disclosure.

Referring to FIGS. 5A and 5B, the system 500 may include an electronic device 104′ similar to the electronic device 104 as explained in the previous paragraphs of the disclosure. In an embodiment, the system 500 may be implemented as an apparatus. The apparatus may include memory storing one or more instructions and at least one processor communicatively coupled to the memory. The instructions, when executed by the at least one processor, may cause the apparatus to perform the operations described with respect to the system 500.

The electronic device 104′ may include the processor 106-2, the memory 108-2, module(s) 510, the applications 105, and the data 112-2. The module(s) 510, amongst other things, include routines, programs, objects, components, data structures, etc., which perform particular tasks or implement data types. The module(s) 510 may also be implemented as, signal processor(s), state machine(s), logic circuitries, and/or any other device or component that manipulate signals based on operational instructions.

Further, the module(s) 510 may be implemented in hardware, instructions executed by at least one processing unit, for e.g., the processor 106-2, or by a combination thereof. The processing unit may comprise a computer, a processor, a state machine, a logic array and/or any other suitable devices capable of processing instructions. The processing unit may be a general-purpose processor which executes instructions to cause the general-purpose processor to perform operations or, the processing unit may be dedicated to perform the required functions. In some example embodiments, the module(s) 110 may be machine-readable instructions (software, such as web-application, mobile application, program, etc.) which, when executed by a processor/processing unit, perform any of the described functionalities.

In an embodiment of the disclosure, the module(s) 510 may be implemented as part of the processor 106-2. In another embodiment of the disclosure, the module(s) 510 may be external to the processor 106-2. In yet another embodiment of the disclosure, the module(s) 510 may be part of the memory 108-2. In another embodiment of the disclosure, the module(s) 510 may be part of hardware, separate from the processor 106-2.

In the illustrated embodiment, the module(s) 510 may include an extraction module 512, a bundling module 514, an embedding module 516, and an initializing module 518. The extraction module 512, the bundling module 514, the embedding module 516, and the initializing module 518 are in communication with each other.

In an embodiment, the processor 106-2 may be configured to extract, at the time of booting the electronic device 104′, shader data and pipeline data 502 associated with each application from among a plurality of applications, i.e., the applications 105, installed in the electronic device 104′. Referring to FIGS. 5A and 5B, in the illustrated embodiment, the extracting module 512 may be configured to extract the shader data and the pipeline data associated with each application 105 installed/deployed in the electronic device 104′.

The extracting module 512 may be configured to initialize a virtual-display rendering service 522 at the time of booting the electronic device 104′. Further, the extracting module 512 may be configured to render, in the electronic device 104′, each application 105 in the virtual-display rendering service 522 when the electronic device 104′ is in an idle state. The idle state herein may be referred to an operational state of the electronic device 104′ when the user is not operating such device 104′, without departing from the scope of the disclosure.

The extracting module 512 may be configured to generate the shader data and the pipeline data 520 associated with each application 105 based on the rendering of each application 105. Further, the extracting module 512 may be configured to store the generated shader data and the generated pipeline data 520 in a data repository 524 of the electronic device 104′. In the illustrated embodiment, the data repository 524 may be embodied as a standalone repository or the memory 108-2 of the electronic device 104′. Further, the extracting module 512 may be configured to extract the generated shader data and the generated pipeline data 520 from the data repository 524 associated with each application 105 at the time of booting the electronic device 104′.

Further, the processor 106-2 may be configured to bundle the extracted shader data and the extracted pipeline data 520 with the OS binary of the electronic device 104′. In the illustrated embodiment, the bundling module 514 may be configured to bundle the extracted shader data and the extracted pipeline data 520 with the OS binary of the electronic device 104′. The bundling module 514 may be configured to retrieve the extracted shader data and the extracted pipeline data 520 from the data repository 524 and, bundle the retrieved data with the OS binary of the electronic device 104′. The bundled data, i.e., the shader data and the generated pipeline data with the OS binary, may be referred to as the OS binary with cache 526 in the FIG. 5B of the disclosure. The OS binary with cache 526 may interchangeably be referred to as the bundled shader data and the bundled pipeline data 526.

The processor 106-2 may be configured to embed the bundled shader data and the bundled pipeline data 526 of each application 105 from the OS into the corresponding application resources 528. In the illustrated embodiment, the embedding module 516 may be configured to embed the bundled shader data and the bundled pipeline data 526 of each application 105 into the corresponding application resources 528.

The processor 106-2 may be configured to fetch the embedded shader data and the embedded pipeline data from the corresponding application resources at a time of initializing each application 105 in the electronic device 104′. In the illustrated embodiment, the initializing module 518 may be configured to fetch the embedded shader data and the embedded pipeline data from the corresponding application resources 528 at the time of initializing each application 105 in the electronic device 104′. The time of initializing each application 105 may be referred to the time at which the application 105 is launched in the electronic device 104′.

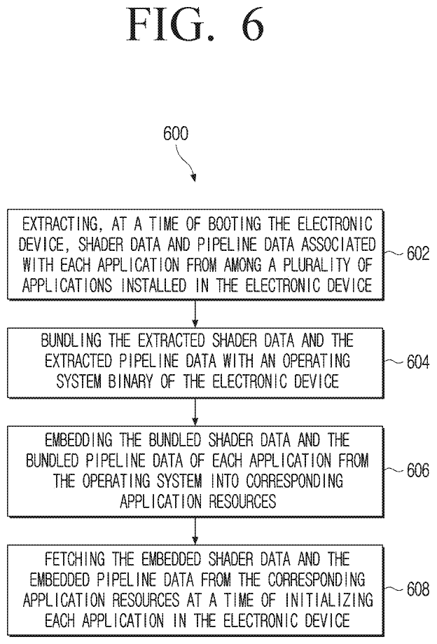

FIG. 6 illustrates a flowchart depicting a method 600 for reducing launch-time of the applications 105 in the electronic device 104′, according to an embodiment of the disclosure. The method 600 may be implemented in the system 500 using components thereof, as described above. In an embodiment, the method 600 may be executed by the processors 106-1 of the electronic device 104′, as described above with respect to FIGS. 5A and 5B. Further, for the sake of brevity, details of the disclosure that are explained in detail in the description of FIGS. 1 to 4, 5A, and 5B are not explained in detail in the description of FIG. 6.

At operation 602, the method 600 may include extracting, at the time of booting the electronic device 104′, the shader data and pipeline data 520 associated with each application 105 from among the plurality of applications installed in the electronic device 104′. In an embodiment, the method 600 may include initializing the virtual-display rendering service 522 at the time of booting the electronic device 104′. Further, the method 600 may include rendering, in the electronic device 104′, each application 105 in the virtual-display rendering service 522 when the electronic device 104′ is in the idle state.

Furthermore, the method 600 may include generating the shader data and the pipeline data 520 associated with each application 105 based on the rendering of each application 105. Upon generation, the method 600 may include storing the generated shader data and the generated pipeline data 520 in the data repository 524. Further, the method 600 may include extracting the generated shader data and the generated pipeline data 520 from the data repository 524 associated with each application 105 at the time of booting the electronic device 104′.

At operation 604, the method 600 may include bundling the extracted shader data and the extracted pipeline data 520 with the OS binary of the electronic device 104′.

At operation 606, the method 600 may include embedding the bundled shader data and the bundled pipeline data 526 of each application 105 from the operating system into the corresponding application resources 528.

At operation 608, the method 600 may include fetching the embedded shader data and the embedded pipeline data from the corresponding application resources 528 at the time of initializing each application 105 in the electronic device 104′.

As would be gathered, the disclosure offers a comprehensive approach of reducing application launch-time in the electronic device 104, 104′. The systems 100, 500 and the methods 400, 600 of the disclosure generate, ahead of time, the shader data and the pipeline data associated with each application in the electronic device and subsequently, store the generated data in the data repository. Each application in the electronic device 104, 104′ can retrieve the shader data and the pipeline data from the data repository to perform graphical rendering for UI of each application when such application is to be launched in the electronic device 104, 104′. This eliminates the requirement of dynamic shader generation and Just-in-Time (JIT) compilation at the time of launching the application. Therefore, this eliminates any time delay due to compilation of shaders or early-onset janky frames in UI of the application, when such application is launched in the electronic device.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for reducing application launch-time in an electronic device, the method comprising:
creating scripts of at least one application deployed in the electronic device;
generating shader data and pipeline data by executing the created scripts of the at least one application;
bundling the generated shader data and the generated pipeline data with an operating system binary of the electronic device;
embedding the bundled shader data and the bundled pipeline data into the at least one application at a time of booting the electronic device; and
initializing the at least one application using the embedded shader data and the embedded pipeline data.

2. The method according to claim 1, wherein the generating of the shader data and the pipeline data comprises:
emulating, using the created scripts, user interactions with each user interface (UI) associated with the at least one application deployed in the electronic device;
generating the shader data and the pipeline data associated with each UI of the at least one application based on the emulating of the user interactions; and
storing the generated shader data and the generated pipeline data in a data repository.

3. The method according to claim 2, further comprising:
extracting, from the data repository, the generated shader data and the generated pipeline data corresponding to the at least one application deployed in the electronic device;
bundling the extracted shader data and the pipeline data with the operating system; and
deploying the operating system along with the bundled shader data and the bundled pipeline data in the electronic device.

4. The method according to claim 3, wherein the embedding of the bundled shader data and the bundled pipeline data into the at least one application comprises:
embedding the bundled shader data and the bundled pipeline data into application resources associated with the at least one application.

5. The method according to claim 4, wherein the initializing of the at least one application using the embedded shader data and the embedded pipeline data comprises:
extracting the embedded shader data and the embedded pipeline data from the application resources associated with the at least one application; and
initializing the at least one application by rendering UI elements associated with UI of the at least one application based on the extracted shader data and the extracted pipeline data on the electronic device.

6. A method for reducing launch-time of applications in an electronic device, the method comprising:
extracting, at a time of booting the electronic device, shader data and pipeline data associated with each application from among a plurality of applications installed in the electronic device;
bundling the extracted shader data and the extracted pipeline data with an operating system binary of the electronic device;
embedding the bundled shader data and the bundled pipeline data of each application from the operating system into corresponding application resources; and
fetching the embedded shader data and the embedded pipeline data from the corresponding application resources at a time of initializing each application in the electronic device.

7. The method according to claim 6, wherein the extracting of the shader data and the pipeline data comprises:
initializing a virtual-display rendering service at the time of booting the electronic device; and
rendering, in the electronic device, each application in the virtual-display rendering service when the electronic device is in an idle state.

8. The method according to claim 7 further comprising:
generating the shader data and the pipeline data associated with each application based on the rendering of each application;
storing the generated shader data and the generated pipeline data in a data repository of the electronic device; and
extracting the generated shader data and the generated pipeline data from the data repository associated with each application at the time of booting the electronic device.

9. An apparatus for reducing application launch-time in an electronic device, the apparatus comprising:
memory storing one or more instructions; and
at least one processor communicatively coupled to the memory,
wherein the instructions, when executed by the at least one processor individually or collectively, cause the apparatus to:
create scripts of at least one application deployed in the electronic device,
generate shader data and pipeline data by executing the created scripts of the at least one application,
bundle the generated shader data and the generated pipeline data with an operating system binary of the electronic device,
embed the bundled shader data and the bundled pipeline data into the at least one application at a time of booting the electronic device, and
initialize the at least one application using the embedded shader data and the embedded pipeline data.

10. The apparatus according to claim 9, wherein to generate the shader data and the pipeline data, the instructions, when executed by the at least one processor individually or collectively, cause the apparatus to:
emulate, using the created scripts, user interactions with each user interface (UI) associated with the at least one application deployed in the electronic device,
generate the shader data and the pipeline data associated with each UI of the at least one application based on the emulating of the user interactions, and
store the generated shader data and the generated pipeline data in a data repository.

11. The apparatus according to claim 10, wherein the instructions, when executed by the at least one processor individually or collectively, cause the apparatus to:
extract, from a data repository, the generated shader data and the generated pipeline data corresponding to the at least one application deployed in the electronic device,
bundle the extracted shader data and the pipeline data with the operating system, and
deploy the operating system along with the bundled shader data and the bundled pipeline data in the electronic device.

12. The apparatus according to claim 11, wherein to embed the bundled shader data and the bundled pipeline data into the at least one application, the instructions, when executed by the at least one processor individually or collectively, cause the apparatus to:
embed the bundled shader data and the bundled pipeline data into application resources associated with the at least one application.

13. The apparatus according to claim 12, wherein to initialize the at least one application using the embedded shader data and the embedded pipeline data, the instructions, when executed by the at least one processor individually or collectively, cause the apparatus to:
extract the embedded shader data and the embedded pipeline data from the application resources associated with the at least one application, and
initialize the at least one application by rendering UI elements associated with UI of the at least one application based on the extracted shader data and the extracted pipeline data on the electronic device.
